(19) United States
(12) Patent Application Publication
(10) Pub. No.: US 2009/0025085 A1
(43) Pub. Date: Jan. 22, 2009

(54) METHOD AND SYSTEM FOR DOWNLOADING DRM CONTENT

(75) Inventors: Hyoung-Shick KIM, Suwon-si (KR); Won-Seok Kwon, Suwon-si (KR); Yun-Sang Oh, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/019,751

(22) Filed: Jan. 25, 2008

(30) Foreign Application Priority Data
Jul. 16, 2007 (KR) 10-2007-0071202

(51) Int. Cl. G06F 21/00

(52) U.S. Cl. 726/26

(57) ABSTRACT

A method and system for downloading DRM contnt are provided. The method includes a first device supporting DRM technology and acquiring content information from a download descriptor downloaded from a content provider system, the first device transmitting the acquired content information to a second device not supporting DRM technology, and the second device downloading the DRM content from the content provider system using the downloaded content information.

### CROSS-REFERENCE TO RELATED APPLICATION

This application claims priority from Korean Patent Application No. 10-2007-0071202 filed on Jul. 16, 2007, in the Korean Intellectual Property Office, the disclosure of which is incorporated herein by reference in its entirety.

### BACKGROUND OF THE INVENTION

1. Field of the Invention

Methods and systems consistent with the present invention relate to downloading DRM content, and, more particularly, to a method and system for downloading DRM content directly to a device that does not support DRM technology.

2. Description of the Related Art

The growth of the Internet and the development of the multimedia technology have made it easy to distribute and acquire digital content. Protecting the copyrights of such digital content is emerging as an important issue.

In order to protect content owners' copyrights and to prevent consumers from illegally using content, DRM (Digital Rights Management) involves ensured distribution and proliferation of content, content control according to a policy, and so on. In DRM, any one is allowed to freely access encoded digital content, but a license is needed to decrypt and play the encrypted digital content. Accordingly, when the DRM is applied, the digital content can be more effectively protected. Functions of DRM technology are largely classified into protection of digital content, management of unique use rules, and management of a billing system.

By such DRM technology, digital content is protected through an encryption process so as to prevent illegal distribution and use of the digital content throughout the processes of generation, distribution, use, and disuse. DRM allows only a legal user having an encryption key to decrypt and use the encrypted content. Even if the content is illegally distributed, the user cannot use the content without a key, which prevents the content from being illegally used.

Recently developed DRM technologies support domain technologies, allowing DRM content to be freely shared within users' domains. One representative DRM technology that supports domain technologies is described in detail in the OMA (Open Mobile Alliance) DRM version 2.0 specification. In the OMA DRM version 2.0, content for a domain can be reproduced from one device belonging to the domain without special limitation to then be transmitted to another device belonging to the domain. That is, an OMA DRM version 2.0 compatible device downloads a DRM content and a Rights Object (RO), and then shares the downloaded DRM content format and RO with another device in the domain.

The devices belonging to the domain constitute a UPnP (Universal Plug and Play) network. In the UPnP network, the respective devices may be divided into a media server storing and transmitting content, media player reproducing content, and a control point controlling the servers. Since DRM technology is associated with codecs, DRM is generally applied only to the media player.

As described above, since DRM technology is generally applied only to the media player, the media server and the control point cannot directly download from a content provider system, which is inconvenient. In addition, since the DRM content format and RO are downloaded by the media player, and then transmitted to the media server for storage, considerable time and cost are required for performing communications.

### SUMMARY OF THE INVENTION

The present invention provides a method and system for directly downloading DRM content to a device that does not support DRM technology.

The present invention also provides a method and system for effectively downloading DRM content to a device that does not support DRM technology in association with a device that supports DRM technology.

The above and other objects of the present invention will be described in or be apparent from the following description of the exemplary embodiments.

According to an aspect of the present invention, there is provided a method of downloading DRM content, the method including: a first device supporting DRM technology acquiring content information from a download descriptor downloaded from a content provider system, the first device transmitting the acquired content information to a second device not supporting DRM technology, and the second device downloading the DRM content from the content provider system using the downloaded content information.

According to another aspect of the present invention, there is provided a system for downloading DRM content, the system including a first device supporting DRM technology which acquires content information from a download descriptor downloaded from a content provider system, and a second device not supporting DRM technology, and which downloads the DRM content from the download descriptor downloaded from the first device.

### BRIEF DESCRIPTION OF THE DRAWINGS

The above and other features and advantages of the present invention will become apparent and more readily appreciated from the following description of the exemplary embodiments, taken in conjunction with the accompanying drawings of which:

FIG. 1 is a block diagram of a system for downloading DRM content according to an exemplary embodiment of the present invention;

FIG. 2 is a flowchart of a method for downloading DRM content according to an exemplary embodiment of the present invention;

FIG. 3 is a flowchart of a method for downloading DRM content according to another exemplary embodiment of the present invention; and

FIG. 4 is a flowchart of a method for downloading DRM content according to still another exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the claims. Like reference numerals refer to like elements throughout the specification.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer readable memory that can direct a computer or other programmable data processing apparatus to function in a particular manner, such that the instructions stored in the computer usable or computer readable memory produce an article of manufacture including instruction means that implement the function specified in the flowchart block or blocks. The computer program instructions may also be loaded into a computer or other programmable data processing apparatus to cause a series of operational steps to be performed in the computer or other programmable apparatus to produce a computer implemented process such that the instructions that execute in the computer or other programmable apparatus provide steps for implementing the functions specified in the flowchart block or blocks.

And each block of the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order, depending upon the functionality involved.

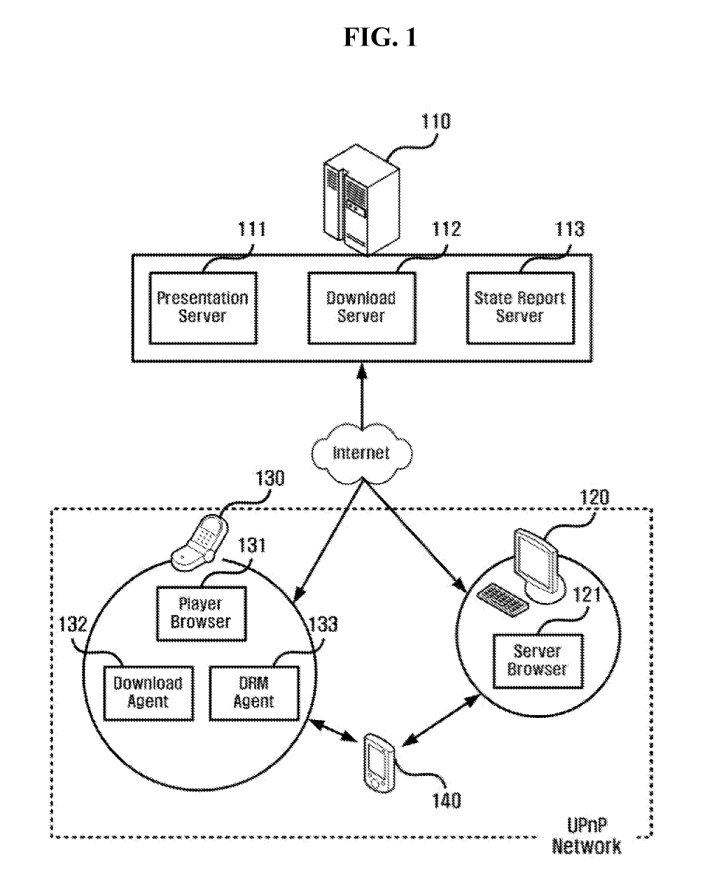

FIG. 1 is a schematic diagram of a system for downloading DRM content according to an exemplary embodiment of the present invention.

A content provider system 110 includes a presentation server 111, a download server 112, and a state report server 113.

The presentation server 111 is a web server that enables users to browse or search content. The presentation server 111 allows a user to select content and make a payment for the content. Once a payment is made by the user, the presentation server 111 transmits, i.e., downloads, a download descriptor to the user's device for which payment has been made. The download descriptor defines content information (e.g., type, objectURI, Right-Issuer URL, etc.) for downloading the content, and instructions for the download agent 132.

The download server 112 provides download service for content selected by the user. The download server 112 downloads a DRM content format (DCF) or a rights object (RO) to a user's device.

The state report server 113 collects content's download state information and reports regarding installation and use information from the user's device.

The media server 120 downloads and stores the DRM content format from the download server 112. The media server 120 includes a UPnP MediaServer component. The media server 120 functions as a server of a home network such as a UPnP network. The media server 120 may be constructed of a personal computer (PC), a set-top box, a digital TV, a game device, and other devices. The media server 120 may be a device that does not support any DRM technology, or a device that does not support DRM technology applied to a desired DRM content format. In an exemplary embodiment of the present invention, the media server 120 is a device that does not support the OMA DRM version 2.0.

The media server 120 includes a server browser 121 that accesses the presentation server 111 to browse and select content, and make a payment. The server browser 121 downloads a download descriptor from the presentation server 111.

The media player 130 plays back a DRM content format. The media player 130 includes a UPnP MediaRenderer component. The media player 130 may be a mobile phone, a PDA, an MP3 media player, a PMP, or others. The media player 130 is a device that supports DRM technology applied to a desired DRM content format. In an exemplary embodiment of the present invention, the media player 130 is a device that supports OMA DRM version 2.0.

The media player 130 includes a player browser 131 which accesses the presentation server 111 to browse and select content, and makes payment. The media player 130 includes a download agent 132 that acquires content information for downloading content from the download descriptor. The media player 130 includes a DRM agent 133 that is responsible for content use control according to a RO, and management of RO in order to play the DRM content format.

The control point 140 controls various devices within the network through the media server 120. The control point 140 includes a UPnP ControlPoint component. The control point 140 may construct independent hardware such as a remote controller, or may be embedded in the media server 120 or the media player 130.

The control point 140 transfers the download descriptor or the content information between the media server 120 and the media player 130. The control point 140 checks the downloading capability of the media server 120, and transmits the same to the media player 130.

Communication is performed between the content provider system 110 and the media server 120, or between the content provider system and the media player 130 using HTTP (hypertext transfer protocol).

Accordingly, the content provider system 110, the media server 120, and the media player 130 support an HTTP Protocol Stack.

Communication is performed between each of the media server 120, the media player 130, and the control point 140 using UPnP (Universal Plug and Play).

Accordingly, the media server 120, the media player 130, and the control point 140 support UPnP. In addition, the media server 120, the media player 130, and the control point 140 support a UPnP method for downloading DRM content.

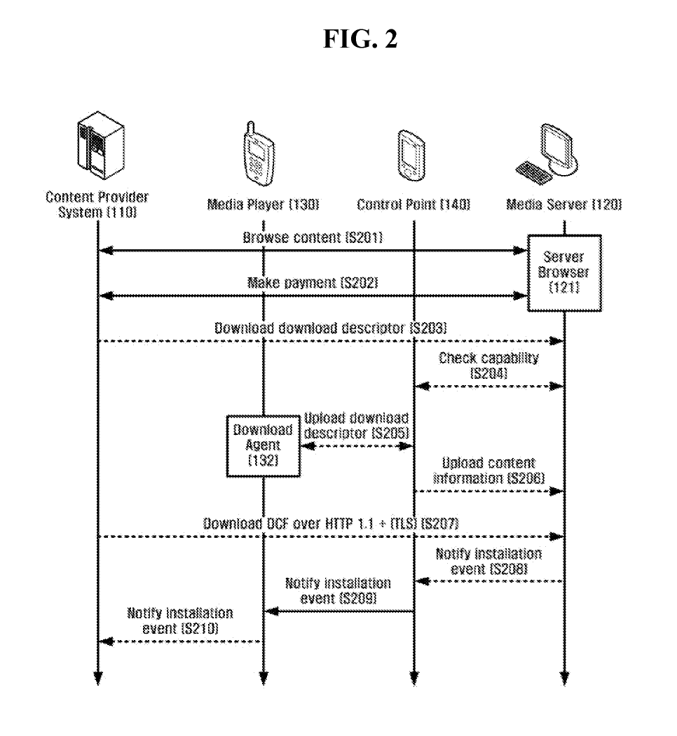

FIG. 2 is a flowchart of a method for downloading DRM content according to an exemplary embodiment of the present invention.

A user actuates the server browser 121 of the media server 120 through the control point 140. The server browser 121 of the media server 120 accesses the presentation server 111 of the content provider system 110 and browses content, e.g., a website, to select the same in step S201. The server browser 121 of the media server 120 accesses the presentation server 111 of the content provider system 110 using the HTTP protocol.

After selecting the content, the user makes payment using the server browser 121 of the media server 120 in step S202. The server browser 121 of the media server 120 performs the payment using a payment module installed in the presentation server 111 of the content provider system 110.

When the payment is completed, the presentation server 111 of the content provider system 110 transmits a download descriptor to the media server 120 in step S203. Here, the presentation server 111 of the content provider system 110 performs the downloading of the download descriptor using HTTP. The download descriptor defines content information for downloading content, e.g., content type, objectURI, Right-Issuer URL, etc., and instructions for the download agent 132.

After the download descriptor is downloaded, the control point 140 checks downloading capability of the media server 120 in step S204. Here, the reason why the control point 140 checks the downloading capability of the media server 120 is because information about downloading capability is required when downloading DRM content in accordance with the OMA DRM version 2.0. Communication between the control point 140 and the media server 120 is performed using the UPnP interface. The media server 120 returns an unprocessed download descriptor and the downloading capability to the control point 140 using the X_GetDD(Out DD) method and the X_GetCapability(Out Space) method.

After checking a storage space, the control point 140 transmits, i.e., uploads, the download descriptor that is not processed by the media server 120 and the checked downloading capability to the media player 130 in step S205. Communication between the control point 140 and the media player 130 is performed in accordance with the UPnP.

The download agent 132 of the media player 130 acquires content information from the checked downloading capability and the download descriptor. The download agent 132 of the media player 130 extracts ObjectURI, which is downloading position information of the DRM content. The media player 130 returns ObjectURI for a particular DRM content from the download descriptor to the control point 140 by the X_GetObjectURI (InDD, In Space, Out ObjectURI) method.

The control point 140 transmits, i.e., uploads, the acquired content information to the media server 120 in step S206. The control point 140 transfers ObjectURI to the media server 120 by an X_SetObjectURI(In ObjectURI) method.

The media server 120 receives, i.e., downloads, the DRM content format (DCF) from the download server 112 of the content provider system 110 using the downloaded content information in step S207. The media server 120 requests the download server 112 of the content provider system 110 to download the DRM content format using ObjectURI by an HTTP Get method. In response thereto, the download server 112 of the content provider system 110 downloads the DCF to the media server 120 by an HTTP Response method.

When the downloading of the DRM content format is completed, the media server 120 notifies the control point 140 via the downloaded state information as to whether the downloading of the DRM content format has been successfully completed, in step S208. That is, the media server 120 generates an installation event of the downloaded state information to then transfer the generated installation event to the control point 140. The installation event contains ObjectURI information and the downloaded state information.

In step S209, the control point 140 notifies the media player 130 of the installation event, i.e., the downloaded state information. Upon receipt of the installation event, the control point 140 notifies the media player 130 of the downloaded state information using ObjectURI contained in the event as an input parameter by the X_Notify(In ObjectURI, In Status, In Status, Out Result) method.

The media player 130 notifies the state report server 113 of the content provider system 110 of the installation event, i.e., the downloaded state information, in step S210. Here, the notification by the media player 130 is performed using HTTP.

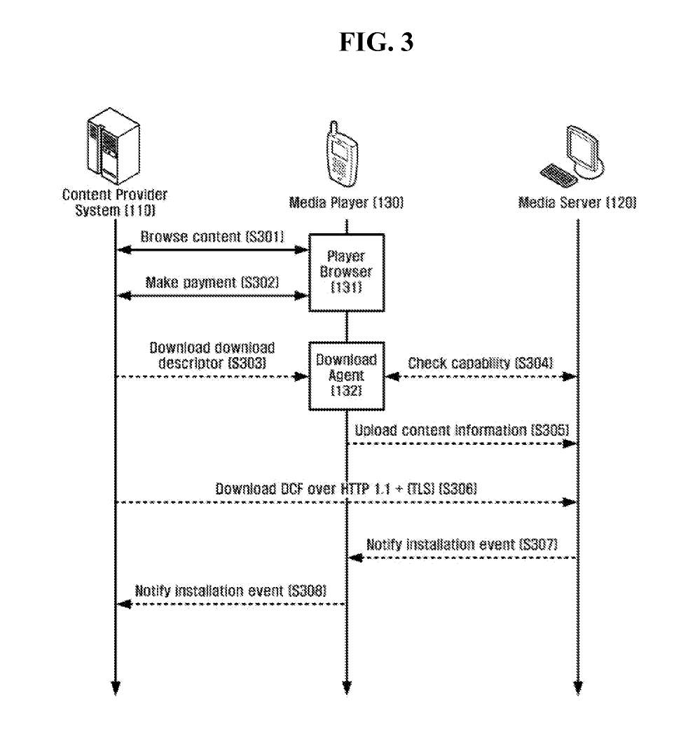

FIG. 3 is a flowchart of a method for downloading DRM content according to another exemplary embodiment of the present invention.

According to the current exemplary embodiment, a control point 140 is included in a media player 130, or the media player 130 is directly manipulated by a user.

The user manipulates the media player 130 to actuate a player browser 131 of the media player 130. The player browser 131 of the media player 130 accesses a presentation server 111 of the content provider system 110 and browses content, e.g., a website, to select the same in step S301. The player browser 131 of the media server 120 accesses the presentation server 111 of the content provider system 110 using HTTP.

After selecting the content, the user makes payment through the player browser 131 of the media player 130 in step S302. The player browser 131 of the media player 130 performs payment using a payment module installed in the presentation server 111 of the content provider system 110.

When the payment is completed, the presentation server 111 of the content provider system 110 transmits a download descriptor to the media server 120 in step S303. Here, the presentation server 111 of the content provider system 110 performs the downloading of the download descriptor using HTTP. The download descriptor defines content information for downloading content, e.g., content type, objectURI, Right-Issuer URL, etc., and instructions for the download agent 132.

After the downloading of the download descriptor is completed, the media player 130 checks downloading capability of the media server 120 in step S304. Here, the reason why the control point 140 checks the downloading capability of the media server 120 is because information about downloading capability is required when downloading DRM content format in accordance with the OMA DRM version 2.0. Communication between the media player 130 and the media server 120 is performed using the UPnP interface. The media server 120 returns downloading capability to the media player 130 by using the X_GetCapability(Out Space) method.

The download agent 132 of the media player 130 acquires an identified downloading capability and content information from the download descriptor. In detail, the download agent 132 of the media player 130 extracts ObjectURI, which is downloading position information of the DRM content, from the download descriptor.

The media player 130 transmits, i.e., uploads, the acquired content information to the media server 120 in step S305. Here, the media player 130 performs the uploading of ObjectURI to the media server 120 by using the X_SetObjectURI(In ObjectURI) method.

The media server 120 downloads a DRM content format (DCF) from the download server 112 of the content provider system 110 using the downloaded content information in step S306. The media server 120 requests the download server 112 of the content provider system 110 using ObjectURI to transmit the DCF using the HTTP Get method. In response thereto, the download server 112 of the content provider system 110 downloads the DRM content format to the media server 120 using the HTTP Response method.

After the downloading of the DRM content format is completed, the media server 120 notifies the media player 130 of the downloaded state information as to whether the downloading of the DRM content format has been successfully completed or failed, in step S307. That is, the media server 120 generates an installation event of the downloaded state information to then transfer the generated installation event to the media player 130. The event contains ObjectURI information and the downloaded state information.

In step S308, the media player 130 notifies the state report server 113 of the content provider system 110 of the downloaded state information. Here, the notification by the media player 130 is performed using HTTP.

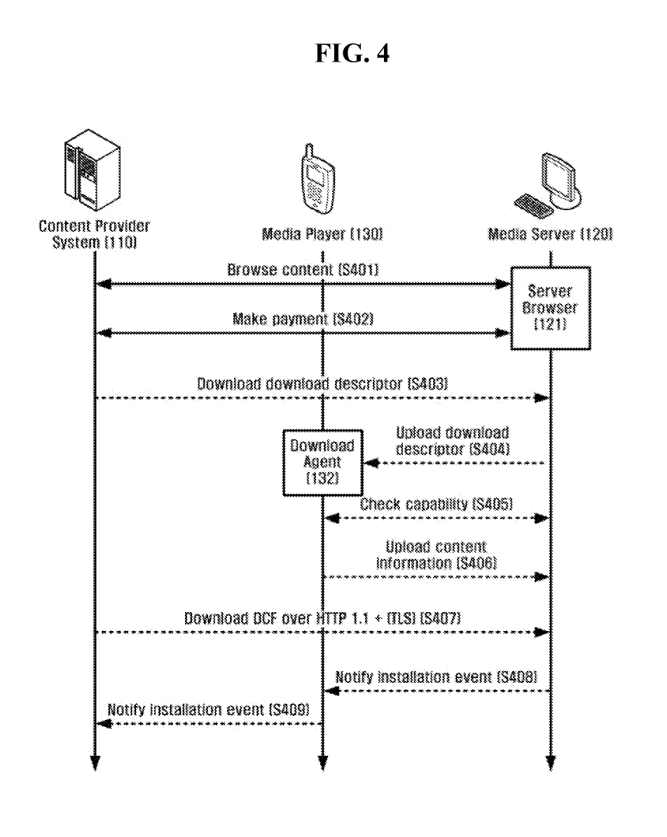

FIG. 4 is a flowchart of a method for downloading DRM content according to still another exemplary embodiment of the present invention.

According to the current exemplary embodiment, a control point 140 is included in a media player 130, or the media player 130 is directly manipulated by a user.

The user manipulates the media server 120 to actuate a server browser 121 of the media server 120. The server browser 121 of the media server 120 accesses a presentation server 111 of the content provider system 110 and browses content, e.g., a website, to select the same in step S401. The server browser 121 of the media server 120 accesses the presentation server 111 of the content provider system 110 using HTTP.

After selecting the content, the user makes payment through the server browser 121 of the media server 120 in step S402. The server browser 121 of the media server 120 performs payment using a payment module installed in the presentation server 111 of the content provider system 110.

When the payment is completed, the presentation server 111 of the content provider system 110 transmits a download descriptor to the media server 120 in step S403. Here, the presentation server 111 of the content provider system 110 performs the downloading of the download descriptor using HTTP. The download descriptor defines content information for downloading content (content type, objectURI, Right-Issuer URL, etc.) and instructions for the download agent 132.

After the downloading of the download descriptor is completed, the media server 120 transmits, i.e., uploads, the download descriptor to the download agent 132 of the media player 130 in step S404. Here, communication between the media server 120 and the media player 130 is based on the UPnP interface, and the media server 120 returns unprocessed download descriptor to the media player 130 by the X_GetDD(Out DD) method.

The media server 120 checks downloading capability and transmits a magnitude of the checked downloading capability to the media player 130 in step S405. Here, the media server 120 checks the downloading capability because information about the downloading capability is required when downloading DRM content format in accordance with OMA DRM version 2.0. The media server 120 returns the magnitude of the checked downloading capability to the media player 130 by the X_GetCapability(Out Space) method.

The download agent 132 of the media player 130 acquires content information from the magnitude of the checked downloading capability and the download descriptor. The download agent 132 of the media player 130 extracts ObjectURI, which is downloading position information of the DRM content.

The media player 130 transmits, i.e., uploads, the acquired content information to the media server 120 in step S406. The media player 130 transfers ObjectURI to the media server 120 by an X_SetObjectURI(In ObjectURI) method.

In step S407, the media server 120 downloads a DRM content format (DCF) from the downloaded content information from the download server 112 of the content provider system 110. The media server 120 requests the download server 112 of the content provider system 110 to download the DRM content format using ObjectURI of the HTTP Get method. In response thereto, the download server 112 of the content provider system 110 transmits the DRM content format (DCF)) to the media server 120 by an HTTP Response method.

After the downloading of the DRM content format is completed, the media server 120 notifies the media player 130 of the downloaded state information as to whether the downloading of the DRM content format has been successfully completed or failed, in step S408. The media server 120 generates an installation event of the downloaded state information to then transfer the generated installation event to the media player 130. The installation event contains ObjectURI information and the downloaded state information.

The media player 130 notifies the state report server 113 of the content provider system 110 of the installation event, i.e., the downloaded state information, in step S409. Here, the notification by the media player 130 is performed using HTTP.

As described above, according to an exemplary embodiment of the present invention, methods and systems for directly downloading DRM content provide the following advantages.

First, the DRM content can be directly downloaded to a device that does not support DRM technology without a relay device.

Second, the DRM content can be efficiently downloaded by reducing the complexity of messages for downloading the DRM content to a device that does not support DRM technology.

Third, the DRM content downloading method and system according to the exemplary example of the present invention support a secure and fair DRM content transport protocol that is not contrary to the conventional DRM rules.

The effects of the exemplary embodiment of the present invention are not limited to the foregoing description, and additional effects and advantages of the invention will be made apparent to those skilled in the art from the spirit and scope of the invention as defined by the appended claims.

While a few exemplary embodiments of the present invention have been particularly shown and described, it will be understood by those of ordinary skill in the art that various changes in form and details may be made these exemplary embodiments without departing from the principles and spirit of the invention, the scope of which is defined by the claims and their equivalents.

What is claimed is:

1. A method of downloading Digital Rights Management (DRM) content, comprising:
(a) a first device supporting DRM technology and acquiring content information from a download descriptor downloaded from a content provider system;
(b) the first device transmitting the acquired content information to a second device not supporting DRM technology; and
(c) the second device downloading the DRM content from the content provider system using the downloaded content information.

2. The method of claim 1, wherein the acquiring comprises: the first device requesting the content provider system to transfer the DRM content; the first device downloading the download descriptor from the content provider system; and the first device acquiring the content information from the download descriptor.

3. The method of claim 1, wherein the acquiring comprises: the second device requesting the content provider system to transfer the DRM content; the second device downloading the download descriptor from the content provider system; the second device transmitting the download descriptor to the first device; and the first device acquiring the content information from the downloaded download descriptor.

4. The method of claim 1, wherein the acquiring comprises: the first device checking downloading capability of the second device; and the first device acquiring from the download descriptor the content information using the magnitude of the checked downloading capability.

5. The method of claim 1, wherein the acquiring comprises: the second device requesting the content provider system to download the DRM content by a control point controlling the second device; the second device downloading the download descriptor from the content provider system; the second device transmitting the download descriptor to the control point; the control point transmitting the downloaded download descriptor to the first device; and the first device acquiring the content information from the downloaded download descriptor.

6. The method of claim 1, wherein the acquiring comprises: the control point controlling the second device and checking downloading capability of the second device; the control point transmitting the magnitude of the checked downloading capability to the first device; and the first device acquiring the content information from the download descriptor using the magnitude of the downloading capability transmitted to the first device.

7. The method of claim 1, wherein the transmitting comprises: the first device transmitting the acquired content information to the control point controlling the second device; and
the control point transmitting the downloaded content information to the second device.

8. The method of claim 1, further comprising (d) transmitting download state information of the DRM content to the content provider system.

9. The method of claim 8, wherein the transmitting download state information (d) comprises: the second device transmitting the download state information to the first device; and the first device transmitting the downloaded download state information to the content provider system.

10. The method of claim 8, wherein the transmitting download state information (d) comprises: the second device transmitting the download state information to the control point controlling the second device; the control point transmitting the downloaded download state information to the first device; and the first device transmitting the downloaded download state information to the content provider system.

11. The method of claim 1, wherein the acquiring is performed by a download agent based on OMA (Open Mobile Alliance) DRM included in the first device.

12. The method of claim 1, wherein the download descriptor includes content information regarding content type, objectURI, and Right-Issuer URL according to the OMA DRM specification.

13. The method of claim 1, wherein the content information is an OMA DRM-based ObjectURI.

14. The method of claim 1, wherein the transmitting is performed using UPnP (Universal Plug and Play).

15. The method of claim 1, wherein the downloading is performed using HTTP (hypertext transfer protocol).

16. A system for downloading Digital Rights Management DRM content, comprising:
a first device which supports DRM technology and which acquires content information from a download descriptor downloaded from a content provider system; and
a second device which does not support DRM technology, and which downloads the DRM content from the download descriptor downloaded from the first device.

17. The system of claim 16, wherein the first device requests the content provider system to transfer the DRM content, and downloads the download descriptor from the content provider system.

18. The system of claim 16, wherein the second device requests the content provider system to transfer the DRM content, downloads the download descriptor from the content provider system, and transmits the download descriptor to the first device.

19. The system of claim 16, wherein the first device checks the downloading capability of the second device, and acquires from the download descriptor the content information using the magnitude of the checked downloading capability.

20. The system of claim 16, further comprising the control point which controls the second device, and which transfers the download descriptor and the content information between the first device and the second device.

21. The system of claim 20, wherein the control point checks the downloading capability of the second device, and transmits the magnitude of the checked downloading capability to the first device.
